(19) United States
(12) Patent Application Publication
(10) Pub. No.: US 2016/0092976 A1
(43) Pub. Date: Mar. 31, 2016

(54) ROVING VEHICLE RENTAL SYSTEM AND METHOD

(71) Applicant: 2435603 Ontario Inc., Ottawa (CA)

(72) Inventors: Randall W. MARUSYK, Ottawa (CA); Hilary PHENIX, Ottawa (CA)

(21) Appl. No.: 14/864,440

(22) Filed: Sep. 24, 2015

Related U.S. Application Data
(60) Provisional application No. 62/055,578, filed on Sep. 25, 2014.

(51) Int. Cl. G06Q 30/06; G06Q 50/30

(52) U.S. Cl. CPC G06Q 30/0645; G06Q 50/30

(57) ABSTRACT

A method and system for facilitating vehicle rental are provided. Rental request parameters are received from a first party, including a rental start time, a rental pick-up location, a rental end time and a rental drop-off location. A vehicle available for rent between the rental start time and the rental end time is acquired, and delivery of the vehicle to the rental pick-up location is initiated. A transaction with the user may be performed upon delivery. Retrieval of the vehicle from the rental drop-off location is initiated following the rental end time.

### FIELD OF THE INVENTION

The present invention pertains to car rental services, in particular creating a service provided through a Smartphone App that allows for a preauthorized payment and digital contract agreement procedure, as well as rental car drop-off and pick-up at the customer location.

### BACKGROUND

Traditional rental car companies provide a service to customers that wish to have access to a vehicle. When a customer arrives at a car rental location, they may have pre-booked a vehicle (either over the phone or online) or they may wish to rent one on the spot. The rental procedure involves filling out a contract for the service (including terms of the rental), providing personal information to the company about licensing and insurance, as well as payment and optional security for example, in the form of a credit card. Once the paperwork has been finished and payment received, the customer has full access to the car and may use it according to the terms of the contract.

Most of the business in the rental car market comes from airport and city centre locations; users arrive at the service desk and complete the process there. A wave of consolidation of rental companies has left three major players in the American rental car market with a market share of 95%. This previously has left the dominant firms with no need to compete vigorously. However, these firms have begun to expand their services into other car-share markets due to a shifting car rental market.

Car-share services (also called the car-club model) provide access to a vehicle that is parked in a lot or on the street. City centres are a popular location to set up the car-share services. These services do not utilize a service desk, and they do not require direct contact with a customer following initial sign-up. The customer can obtain a swipe-card after completing an online application process and paying a monthly membership fee. They also offer booking and other services through a Smartphone App, an online forum or over the phone. The memberships are offered to a wide range of customers, including individuals, businesses and universities. The swipe-card will allow a user to hire a car from the car-share company locations, by the hour. This method of car hire is proving appealing to young users in particular, based on the ease and convenience of use.

Another car-use service that is gaining in popularity based on the ease and convenience it provides is a taxi service that connects riders to drivers through a Smartphone App. A user signs up with the company online and provides payment and user information. A taxi driver also signs up in order to be considered to provide the service. Once a profile has been created, the rider can use a Smartphone App to select a pick-up and drop-off location, as well as providing an ETA and route progression. It is also possible to share your ETA with other people online, book split fares with other users and view a fare quote. The service is paid for automatically through your account and once at the destination, the driver drops the rider off. Accounts can be created for individual users, businesses and other organizations.

However, due to various deficiencies in the above-mentioned services, there is a need for a vehicle rental system and method that is not subject to one or more limitations of the prior art.

### SUMMARY

The present invention relates to an approach for facilitating the process of renting a vehicle. In accordance with an aspect of the present invention, there is provided a method for facilitating vehicle rental, comprising: receiving rental request parameters from a first party, said rental request parameters including a rental start time, a rental pick-up location, a rental end time and a rental drop-off location; acquiring a vehicle available for rent between the rental start time and the rental end time; initiating delivery of the vehicle to the rental pick-up location; transacting with the user upon said delivery of the vehicle; and initiating retrieval of the vehicle from the rental drop-off location following the rental end time.

In accordance with another aspect of the present invention, there is provided a system for facilitating vehicle rental, comprising: a client interface device configured to receive rental request parameters from a first party, said rental request parameters including a rental start time, a rental pick-up location, a rental end time and a rental drop-off location; a computing system communicatively coupled to the client interface, the computing system configured to: initiate and direct acquisition of a vehicle available for rent between the rental start time and the rental end time; initiate and direct delivery of the vehicle to the rental pick-up location; receive details related to a transaction with the user upon said delivery of the vehicle; and initiate and direct retrieval of the vehicle from the rental drop-off location following the rental end time.

### BRIEF DESCRIPTION OF THE FIGURES

These and other features of the invention will become more apparent in the following detailed description in which reference is made to the appended drawings.

FIG. 1 illustrates a method for facilitating a vehicle rental, in accordance with various embodiments of the present invention.

FIG. 2 illustrates a system for facilitating a vehicle rental, in accordance with various embodiments of the present invention.

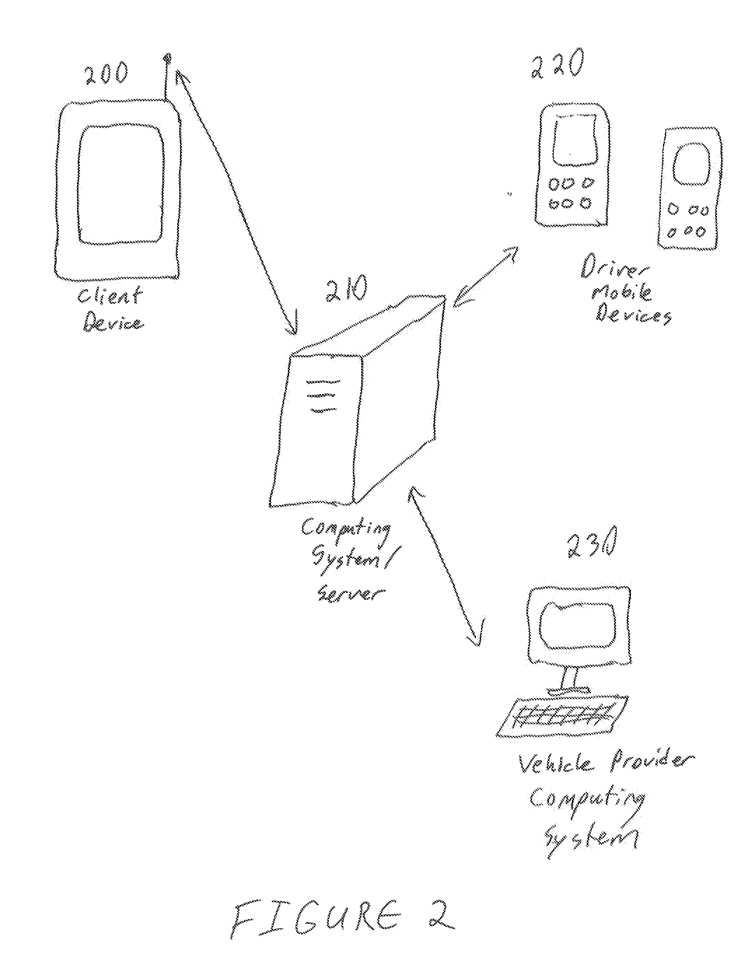

### DETAILED DESCRIPTION OF THE INVENTION

There is a need to make renting or sharing for some valuable consideration, a car or other type of vehicle (such as vans, trucks, machinery including the likes of backhoes, ATV's, snowmobiles, tractors, etc.) easier and more convenient. There is difficulty with current services that have fixed pick-up locations, strict vehicle rental timelines and do not allow for pre-authorized payment and completed paperwork. There is also a need to provide further vehicle renting options in a changing market.

For example, there are some problems with the above-mentioned traditional rental model. The user must attend a service desk or some other physical attendance to set location in order to get access to the car or other vehicle types. They are required to relocate to a traditional rental company premises, reducing the convenience of renting a car. They are also required to fill out paperwork at the service desk if they have not done it online before hand, which requires additional time. Much of this process is repeated each time the user decides to rent a car.

As another example, there are also some problems with the above-mentioned “car share” service model. The customer, although they do not have to fill out paperwork each time they wish to use a car, must attend a car-share company site. If the company does not have a car on-site at the time they require, they will not have a car available to them. Although a user is able to hire a car for up to seven days, the system is designed to provide services for short periods of time and distance. Longer trips may not be accommodated, and prove to be much more expensive. Access for users that live outside of city centres is also quite restricted.

As another example, the above-mentioned taxi service model does not allow the rider to hire the actual car. It only provides a taxi service and the user cannot drive the vehicle; they are only permitted to have a driver take them to the desired location.

An embodiment of the present invention relates to providing a roving car rental service though a Smartphone App or other form of mobile or non-mobile communication including kiosks, phone, computer and the like. The company in one embodiment would set up an online forum (including website, Smartphone App, etc.) in which a user could provide information about licensing, insurance, payment, credit card security, and other details either preempted or at the time of rental. Once the user has gone through the process of providing information, they would be given a membership profile; this profile would be accessed through, for example, the Smartphone App. Membership accounts would be available to individuals, business and other organizations.

In some embodiments, traditional car rental firms may also sign onto the service in order to be considered for the user vehicle rental. They would provide information to the company about pricing, availability, discounts, promotion packages and other details. Once the firm has created a company or individual profile, users would be able to access their vehicles through the roving car rental service. Similarly, in some embodiments, individuals, groups or businesses with a vehicle or vehicles to rent may register with the service to provide details about the vehicles available and other details. Similarly, in some embodiments, individuals, groups or businesses who can provide driver services such as taxi services and/or vehicle pick-up and drop-off may register with the service to provide details about their service availability and details.

In one example, when a user wishes to rent a car, they would open the App and specify rental request parameters, such as selection of a pick-up and drop-off location and time. If they so desired, they could use their Smartphone GPS location to specify where they wished to have the car delivered to. They would also provide information about other rental particulars in relation to the vehicle, such as car model type, insurance coverage, etc. At that time, they would also select how they wish to complete the necessary paperwork. They would be able to choose from a number of options, including pre-authorization, completion upon arrival of vehicle, or completion upon vehicle pick-up. They would also be able to set a preference for their preferred method during the membership application process.

Once the user has finished booking the car, the roving vehicle rental company would provide the service. After coordinating with the traditional vehicle rental firm or other entity sourcing vehicles for rent, they would bring the chosen vehicle to the user at the time and place (using GPS location data if so requested) specified during the selection process. The user would have the choice of course to accept or reject a given vehicle based on their individual preference including but not limited to color, size, location, upgrades and the like. They would fulfill the customer's request to complete paperwork and payment in the method they so choose unless all such steps were previously established. The completion of the paperwork could be coordinated by the company with the traditional rental firm once the car has been dropped off to the user, if the user so devised. All options and combinations would be available to the user.

In some embodiments, the roving vehicle rental company may rent the vehicles from other providers and then rent them in turn to users, with permission from the providers. In some embodiments, the roving vehicle rental company may provide a particular service or medium by which vehicle providers rent vehicles directly to the users.

Upon completion of the rental period, the company would meet the user at the desired drop-off location or come to where the car is located, found through a GPS location of the user. They would complete any remaining requests from the user at this time, and regain possession of the vehicle. The company would then return the vehicle to the traditional vehicle rental firm to complete the transaction.

Secondarily, the embodiment of this invention could include driver service as part of the agreement. The user could select to include a driver in the rental process, essentially renting a taxi service for the period of vehicle rental or for a portion of that period. For example, the driver service may be provided for the purposes of bringing a user to a hotel or airport at the beginning or end of a rental period.

In some embodiments, the user may specify a general pick-up location range, for example within a specified distance of their current GPS location. They may then be informed, for example upon delivery of the vehicle, of the specific pick-up location within that range.

In some embodiments, the user may specify a general drop-off location range upon initiation of the rental, for example a specific airport or even a specific city. They may then inform the company, for example at the end of their vehicle usage term, of the specific drop-off location of the vehicle within that range. This may be performed automatically via communication of the user's GPS coordinates through a smartphone app, or via a built-in GPS location and communication system of the vehicle.

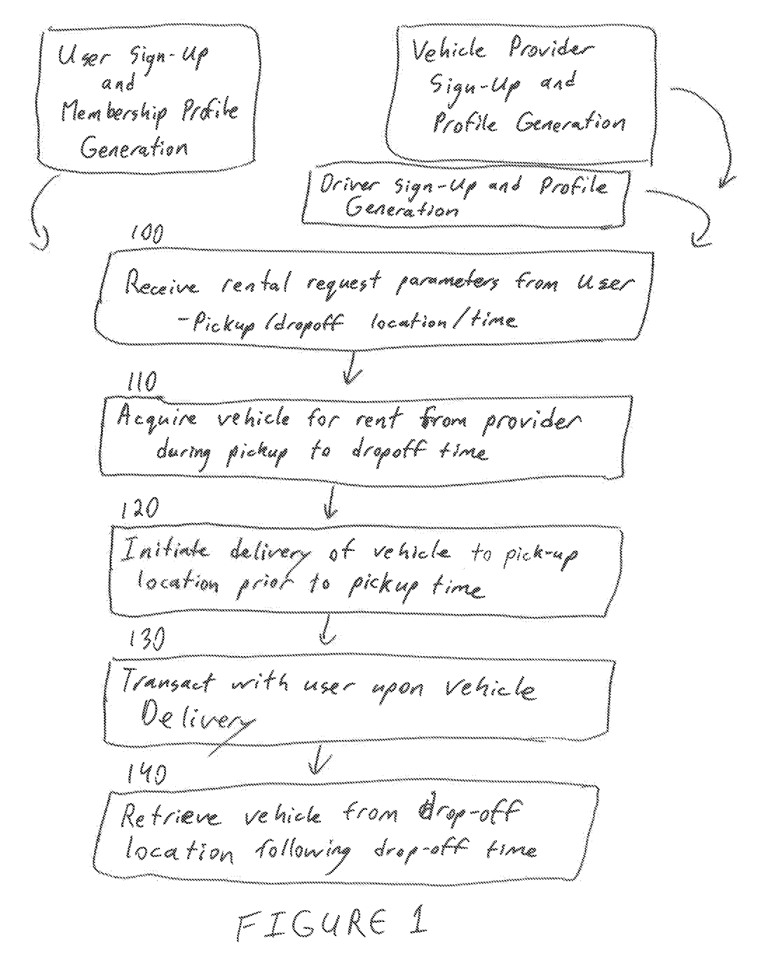

Various embodiments of the present invention relate to a method for facilitating vehicle rental, as described below with respect to FIG. 1. The method includes receiving 100 rental request parameters from a first party, said rental request parameters including a rental start time, a rental pick-up location, a rental end time and a rental drop-off location. These parameters may be received for example via an application installed on a user's smartphone, or via a computer application installed on a dedicated or general-purpose mobile or non-mobile computing device having a wired or wireless communication link to other computing devices, such as a server which is configured to perform operations in furtherance of the vehicle rental. The method includes acquiring 110 a vehicle available for rent between the rental start time and the rental end time. Such acquisition may involve, for example, communicating with one or more vehicle providers to request an available vehicle and negotiate a price. Such communication may be at least partially or may be fully automated. The method includes initiating delivery 120 of the vehicle to the rental pick-up location on or before the rental start time. The method includes initiating retrieval 140 of the vehicle from the rental drop-off location following the rental end time. The delivery and retrieval operations may involve communicating with drivers employed for the purpose of at least delivering and picking up the vehicles, to provide said drivers with instructions regarding where and when to drop off or retrieve a particular vehicle. Such instructions may be generated and provided at least partially automatically. For example, the instructions may be transmitted from a server to the mobile phone device of an available driver via a wireless communication link.

The method optionally includes transacting 130 with the user upon said delivery of the vehicle. Transaction may comprise an indication by the user that the vehicle has been accepted. Transaction may optionally comprise verification of the user's identity and paperwork (paper or electronic), payment, verification of insurance, credit card, signature, and the like. In some embodiments, the transaction may be paperless and signatures, photos or scans of documentation, or the like, may be transmitted to a server for processing and storage. The transaction paperwork parameters may have been pre-specified in a user profile. The transaction may be performed and/or recorded via one or more of: a mobile device of the user, a kiosk, a computing system provided within the vehicle, a computing device in possession of the delivery driver, or the like, or a combination thereof. Security to verify the identity of the user are well known to those skilled in the art.

Various embodiments of the present invention relate to a system for facilitating vehicle rental. The system includes at least a client interface device 200 and a computing system 210 communicatively coupled to the client interface device. The computing system 210 may further be coupled to one or more driver mobile devices 220 and one or more vehicle provider computing systems 230. Communication may be via conventional wired or wireless data communication infrastructure, as appropriate, and may be via one or more intermediary data service providers, such as cellular network providers, internet service providers, and the like. Communication may be via a secured channel where appropriate. The client interface device is configured to receive rental request parameters from a first party, said rental request parameters including a rental start time, a rental pick-up location, a rental end time and a rental drop-off location. The client interface device may, for example, be a kiosk, desktop or laptop computer, smartphone (or another smart device capable of communications between the user and the rental or sharing system)configured via an installed application, or the like. The computing system is configured to initiate and direct acquisition of a vehicle available for rent between the rental start time and the rental end time via communication with both the vehicle provider computing systems 230 and the driver mobile devices 220 and, to arrange for reservation and pickup of the vehicle, respectively. The computing system is configured to initiate and direct delivery of the vehicle to the rental pick-up location via communication with an appropriate one of the driver mobile devices 220. The computing system is further configured to receive details related to a transaction with the user upon said delivery of the vehicle. The client interface device 200 or an appropriate one of the driver mobile devices 220 may be configured to receive said details via user input and communicate same to the computing device. The computing device is further configured to initiate and direct retrieval of the vehicle from the rental drop-off location following the rental end time. The computing device may retrieve confirmation of rental end from the client interface device 200 following drop-off or this may be pre-scheduled. Retrieval is initiated and directed by communicating an instruction to an appropriate driver mobile device 220. The driver may further be instructed to deliver the vehicle to a designated location.

When an instruction is provided to the driver, appropriate GPS coordinates indicative of current or desired vehicle location may automatically be provided to the driver mobile device.

Some embodiments of the invention may overcome one or more issues in vehicle rental convenience by bringing the vehicle directly to the user. The user may also have the availability of the vehicle for a more variable time period relative to existing methods.

Some embodiments of the invention may overcome certain difficulties in renting a vehicle by providing multiple options for payment, contract agreement and other particulars. In some embodiments the user may be allowed to select how they wish to provide these details. The user may be able to choose pre-authorization, completion on-site of vehicle arrival, or upon car pick-up.

Some embodiments of the invention may provide new rental options to the changing market in vehicle rentals by creating an intermediate company that provides traditional rental firms with another means of renting their vehicles.

Various embodiments of the present invention may comprise one or more optimizations, such as negotiating prices at which vehicles are rented from vehicle providers and rented to users, selecting vehicles and/or drivers which are closest to a requested location or otherwise available in the most cost-effective manner, and the like. Optimization routines for providing various efficiencies of the system may be utilized.

In some embodiments, a self-driving vehicle may be used rather than acquiring the services of a driver. With such an embodiment, the user would through a smartphone APP or other communication device, request a car or vehicle based on preset criteria or on criteria options in said APP or device.

The smartphone APP would transmit a user request to a central dispatch application. The user request would specify a pick up request (which may be simply confirming the user's current location) and in some embodiments, either a destination or requested duration of use. Other request parameters can include the number of passengers, and in some embodiments vehicle preferences. The central dispatch application tracks location and bookings for each vehicle and stores this and other information in a database. The central dispatch application would receive the request, and evaluate the request against a database of self-driving vehicles. Accordingly, the central dispatch location can look up the current location and duration of availability for each vehicle to determine which vehicles are available to satisfy the user request. If other criteria or parameters are specified in the user request, the central dispatch application determine which of the available vehicles can meet the criteria specified in the user request. Upon making a selection, the central dispatch application can transmit instructions to a controller of the self-driving vehicle specifying the pick-up location. If a destination is specified, this can included in the same transmission. Accordingly, it should be appreciated that in some embodiments the entire dispatch process can be fully automated.

The self-driving car or vehicle would then proceed to the location of the user. The user would have either pre-selected the criteria for the car or vehicle or could also reject and move to the next car or vehicle available based on the user's criteria. The criteria could be but is not limited to location, vehicle type, color, size, and the like. The self driving vehicle or car could be tracked as it proceeds to the user based on GPS of the user or a preset location. Such systems are well known to those skilled in the art and could be the same as those with the ride sharing service UBER™.

In another embodiment, the price of the self-driving car or vehicle could be set by the availability and location of the user and/or the car or vehicle. The cost of the car or vehicle reaching the user would be integrated into the rental agreement price and could fluctuate based on other criteria as well, such as but not limited to volume. By way of example, if a user requests a certain self-driving car or vehicle the user may finalize the rental. If demand for the car or vehicle rental is high or general, or for a specific model or type, then the rental price may be higher or lower than normal. Such determination of price could be based on an ongoing calculation or could be set based on historical data for a given day, or time of day.

In another embodiment, the rental company may sub contract with other owners of self-driving car or vehicles and coordinate the rental of such said cars or vehicles. The rental company would either split the rental costs with said owners or pay a set fee based on time or usage. This would expand the type and model of self-driving vehicles to the rental user.

Prior to the self-driving car or vehicle being rented, the vehicle could optionally pass though a documentation location comprising one or more cameras that would document the exterior and/or interior of said car or vehicle. Such cameras could be standard camera technology or could be other cameras such as but not limited to x-ray, IR, ultrasound, etc. Once the rental agreement is concluded, said car or vehicle would proceed to a documentation to again be photographed or scanned with the appropriate cameras to determine if there was any damage to the vehicle and/or if the exterior or interior required cleaning. If such cleaning was required, the said self-driving car or vehicle would proceed to a cleaning station that could be manual or automatic as is known to one skilled in the art.

It is also contemplated that the self-driving car or vehicle could optionally, or based on predetermined vehicle measurements such as but not limited to odometer reading, or time of use, pass through a vehicle service location. Such a vehicle service location could provide a variety of services to the vehicle including but not limited to annual maintenance, oil changes, seasonal tire replacement, or otherwise as is known by one skilled in the art. Such service could be performed manually or automatically as is also known by one skilled in the art.

The rental agreement could determine the price based on distance travelled or time spent renting the vehicle. The distance would be determined through traditional odometer readings that would automatically communicate with the rental company or via GPS movement of the vehicle. Additionally, fuel consumption would also be monitored during the rental period regardless of the fuel source (gasoline, diesel, electric, propane, etc.) and the rental rate or charge adjusted based on the consumption (includes and fuel removal by the user from the self-driving vehicle). The self-driving car or vehicle could proceed to be refueled after the rental period concluded. Such refueling could proceed manually or automatically vie methods well known to those skilled in the art.

In some embodiments, pick-up and/or drop-off times may be specified in terms of ranges, rather than specific times. Rental prices may or may not depend on the actual event times of the pick-up and drop-off, for example the length of time separating the two events.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

What is claimed is:

1. A method for facilitating vehicle rental, comprising:
a) receiving rental request parameters from a first party, said rental request parameters including a rental start time, a rental pick-up location, a rental end time and a rental drop-off location;
b) acquiring a vehicle available for rent between the rental start time and the rental end time;
c) initiating delivery of the vehicle to the rental pick-up location;
d) transacting with the user upon said delivery of the vehicle; and
e) initiating retrieval of the vehicle from the rental drop-off location following the rental end time.

2. A system for facilitating vehicle rental, comprising:
a) a client interface device configured to receive rental request parameters from a first party, said rental request parameters including a rental start time, a rental pick-up location, a rental end time and a rental drop-off location;
b) a computing system communicatively coupled to the client interface, the computing system configured to:
i) initiate and direct acquisition of a vehicle available for rent between the rental start time and the rental end time;
ii) initiate and direct delivery of the vehicle to the rental pick-up location;
iii) receive details related to a transaction with the user upon said delivery of the vehicle; and
iv) initiate and direct retrieval of the vehicle from the rental drop-off location following the rental end time.

3. A computer program product for facilitating vehicle rental, the computer program product comprising code which, when loaded into memory and executed on a processor of a computing device, is adapted to execute the method according to claim 1.
